(19) United States
(12) Patent Application Publication
(10) Pub. No.: US 2021/0307519 A1
(43) Pub. Date: Oct. 7, 2021

(54) FOLDING SEAT

(71) Applicant: PBA S.P.A., Tezze Sul Brenta (IT)

(72) Inventor: Francesca MASIERO, Bassano Del Grappa (IT)

(21) Appl. No.: 17/217,438

(22) Filed: Mar. 30, 2021

(30) Foreign Application Priority Data
Apr. 2, 2020 (IT) 102020000006925

(51) Int. Cl. A47C 7/56

(52) U.S. Cl. CPC A47C 7/566

(57) ABSTRACT

A folding seat, having a supporting structure, to be fixed to a wall, for a sitting surface which can be tilted from a vertical inactive position to a horizontal active position by way of a tilting mechanism. The seat includes a group of elements used for adjusting a tilting force.

### CROSS-REFERENCE TO RELATED APPLICATIONS

This application is related to and claims the benefit of Italian Patent Application No. 102020000006925, filed on Apr. 2, 2020, the contents of which are herein incorporated by reference in their entirety.

### TECHNICAL FIELD

The present disclosure relates to a folding seat.

The seat is meant, particularly but not exclusively, to provide seats for people with disabilities and for people with reduced mobility. It can also be used to provide seats for able-bodied people.

### BACKGROUND

As is known, in bathrooms for use by people with reduced mobility, aid elements and furnishings are installed which are designed especially to facilitate the maneuvers of the above mentioned categories of users.

Among these elements are seats that are applied to the walls of bathrooms, including in the shower cubicle, the dimensions, encumbrances, shape and performance of which are prescribed by current regulations.

A series of prescriptions is described in the United States ADA2010 standard, which sets the standards known as “the 2010 ADA Standards for Accessible Design”.

According to these prescriptions, seats, like other aids, must be foldable so as not to present an encumbrance when they are not being used. Users who need to move around using wheelchairs must be able to enter the shower cubicle and be able to access the innermost part of it. In some cases the folding seat in the shower cubicle must be installed on the wall opposite the wall where the shower head is installed, again in order to facilitate movements. Another prescription is that these seats must be foldable by applying a maximum force of 5 pounds (22 N).

The folding seats known today have a supporting structure, to be fixed to a wall typically using brackets, for a sitting surface which can be tilted from a vertical inactive position to a horizontal active position by way of a tilting mechanism. Although nowadays widespread, such seats are susceptible of improvements, since it has been observed that often the tilting occurs in an unbalanced manner, sometimes accompanied also by the unexpected fall of the sitting surface to the horizontal position.

Another drawback is the fact that the sitting surface can be tilted accidentally from the vertical position to the horizontal position, causing hindrance to passage.

Some models of these seats are fitted with springs to dampen the movement of the sitting surface. However, often the springs induce the return of the seat to the vertical position, when it does not support the weight of the user.

### SUMMARY

The aim of the present disclosure is to provide a folding seat for people with disabilities which is capable of improving the known art in one or more of the above mentioned aspects.

Within this aim, the disclosure provides a folding seat that does not rotate accidentally and which at the same time can be easily moved by people with disabilities.

The disclosure also provides a folding seat that ensures a stable hold of the sitting surface in any position and which does not rotate in an uncontrolled manner.

Furthermore, the present disclosure sets out to overcome the drawbacks of the background art in a manner that is alternative to any existing solutions.

Another advantage of the disclosure is to provide a seat that is highly reliable, easy to implement and of low cost.

This aim and these and other advantages which will become better apparent hereinafter are achieved by providing a folding seat, comprising a supporting structure, to be fixed to a wall, for a sitting surface which can be tilted from a vertical inactive position to a horizontal active position by way of a tilting mechanism, said seat being characterized in that it comprises means for adjusting the tilting force.

### BRIEF DESCRIPTION OF THE DRAWINGS

Further characteristics and advantages of the disclosure will become better apparent from the description of a preferred, but not exclusive, embodiment of the seat according to the disclosure, which is illustrated by way of non-limiting example in the accompanying drawings wherein:

FIG. 1 is a perspective view of the seat according to the disclosure in the position of use;

FIG. 2 is a perspective view similar to that of the previous figure of the seat in the position of non-use;

FIG. 3 is a front elevation view of the seat, as in FIG. 1;

FIG. 4 is a cross-sectional side view of the seat in the position of use;

FIG. 5 is a view similar to that of the previous figure of the seat in the position of non-use;

FIG. 6 is an exploded perspective view of the seat according to the disclosure;

FIG. 7 is an enlargement of FIG. 6;

FIG. 8 is another enlargement of FIG. 6; and

FIG. 9 is another exploded perspective view of a part of the seat.

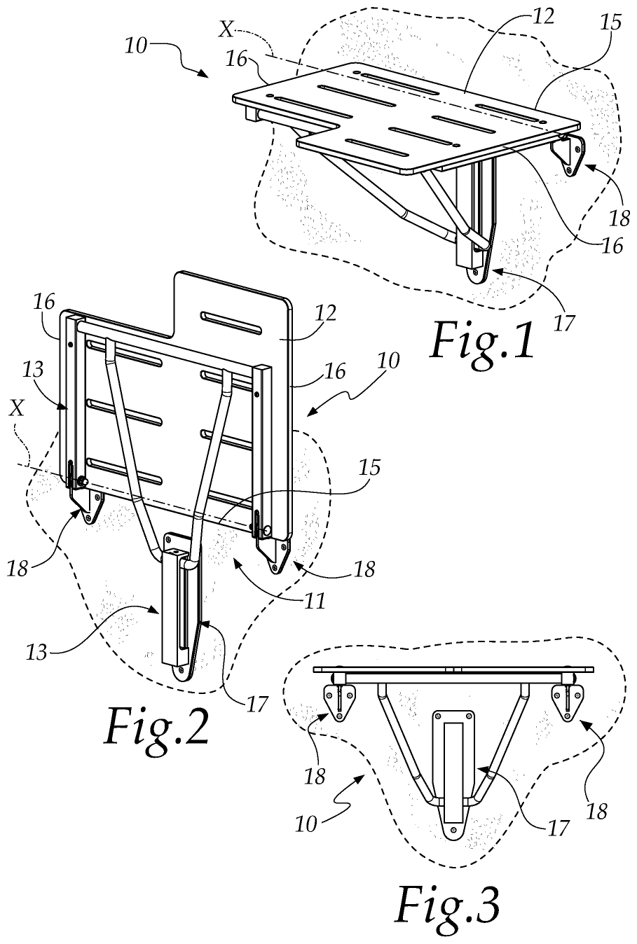

### DETAILED DESCRIPTION OF THE DRAWINGS

With reference to the figures, the seat according to the disclosure, generally designated by the reference numeral 10, comprises a supporting structure 11, to be fixed to a wall, for a sitting surface 12 which can be tilted from a vertical inactive position to a horizontal active position by way of a tilting mechanism 13. The seat 10 also comprises means for adjusting the tilting force 14.

The sitting surface 12, in the example shown, has one side 15 at a region adjacent to the wall and parallel thereto in both positions of the sitting surface 12, and two sides 16 at right angles to the preceding side, which define mutually opposite sides of the sitting surface. In the case shown, there is a widening of the sitting surface 12 owing to which the two sides 16 consequently have a different length. In other embodiments, not shown, these sides 16 can have the same length, thus defining a sitting surface that is substantially rectangular in shape.

The supporting structure 11 comprises a first fixing assembly 17 on the central line of the seat and well below the plane of the sitting surface 12 and two second fixing assemblies 18 in a symmetrical position with respect to the first fixing assembly 17 and close to the ends of the side 15. The three fixing assemblies 17 and 18 are arranged substantially at the vertices of an imaginary isosceles triangle.

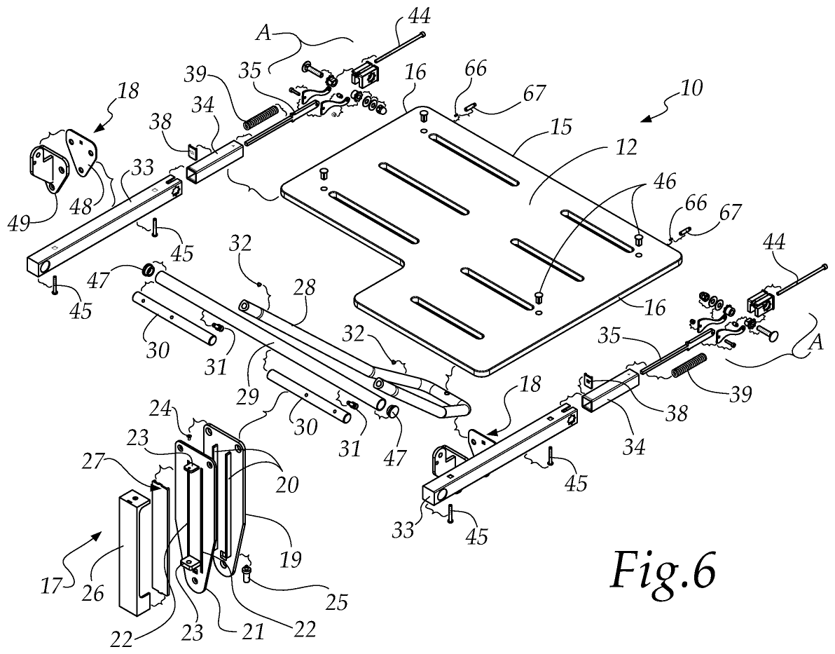

The fixing assembly 17 comprises a bracket 19 for protection, made of plastic material, adapted to be anchored in a known manner to the wall. As illustrated in the exploded view of FIG. 6, this has, on the opposite surface from the surface for anchoring to the wall, a pair of ridges 20 extending longitudinally and in parallel. A complementary bracket 21 is anchored in turn to such bracket 19, and is made of metallic material, with two slits 22, in which the ridges 20 of the previous bracket are positioned, and two cantilevered tabs 23, one upper and the other lower; the first is for fixing, using a first screw 24, a cover 26 with a C-shaped profile that defines a lateral through opening, and the second is a seat for a threaded pin 25 for supporting an element folded substantially in a V-shape 28, described below. The cover 26 is fixed in the upper part using the first screw 24 and is also locked in place with a bayonet-like retention element (not visible) on the lower part. There is also a flat element 27 on the back of the cover 26, on the inner side of this. Such flat element 27 is made of plastic material and has ridges directed toward the ridges 20 of the bracket 19.

The element folded substantially in a V-shape 28 connects the fixing assembly 18 to a horizontal tubular element 29, arranged below the sitting surface 12 with an arrangement parallel to the fixing wall. The element folded substantially in a V-shape 28 has a central portion, horizontal, at which it passes through the fixing assembly 17 and, with the central portion, it is adapted to slide in the opening of the cover 26, in the transition from the position of use of the seat to the position of non-use and vice versa. The ridges 20 and the ridges of the flat element 27 guide and space the element folded substantially in a V-shape 28, so that it is not subjected to abrasion or generate noise during its travel.

The threaded pin 25 has a circular intermediate base and a tip element for centering on the upper part. Screwed on the lower tab 23, it acts as an adjustable support for the element folded substantially in a V-shape 28: by screwing the threaded pin 25 the side opposite to the side 15 is lowered, by unscrewing it is raised.

Inside the tubular element 29, at each one of the opposite ends, two reinforcement tubes 30 are inserted. The element folded substantially in a V-shape 28 is connected with the tubular element 29 by way of a pair of threaded inserts 31, each one protruding from a respective end of the same element 29, which are inserted in adapted holes on the tubular element 29 and, correspondingly, on the tubes 30. A pair of grub screws 32 are inserted in the element folded substantially in a V-shape 28 for screwing the threaded inserts 31.

The tubular element 29 is connected at its ends with the means for adjusting the tilting force 14.

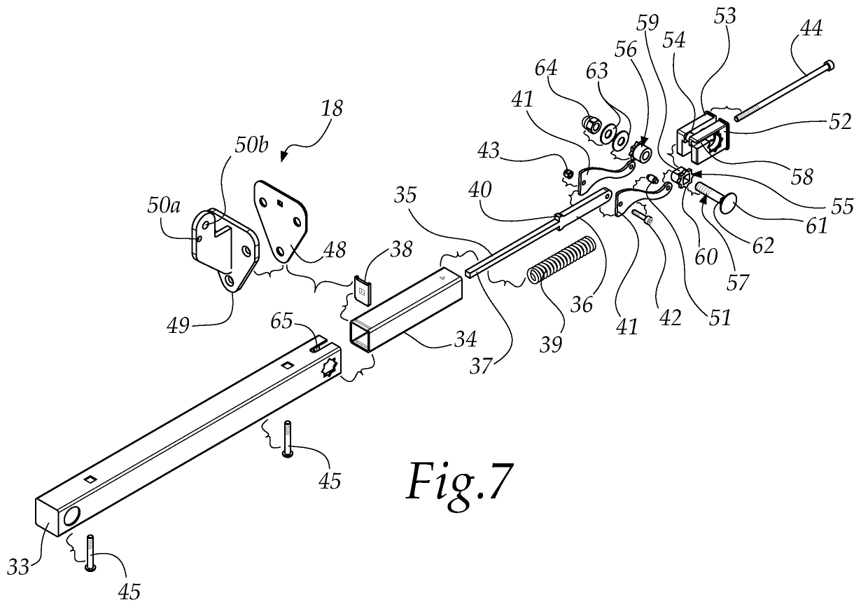

The means for adjusting the tilting force 14 comprise a group of elements (shown and numbered in the enlargement of FIG. 7) installed at each side of the sitting surface 12, with an adjustable helical tension spring 39 which is connected to the fixing assembly 18 for fixing the seat 10 to a wall at a coupling point that is eccentric with respect to the rotation axis X of the sitting surface 12.

The group of elements also comprises:

a first tubular element 33 installed below the sitting surface 12, which is at right angles to the wall when the sitting surface is in the horizontal active position, and which is preferably square in cross-section,

a second tubular element 34, which can translate in the first tubular element 33 and is shorter than it,

a rod 35 which can translate in the second tubular element 34, protrudes from it with a first end portion 37, and also has a second end portion 36, such portions being respectively front and rear in the horizontal active position,

a flat plug 38 at one end of the second tubular element 34 which is provided with a central hole for the first end portion 37 of the rod 35, the helical spring 39 being installed around the rod 35, between the plug 38 and a shoulder 40 of the rod 35, inside the second tubular element 34, the plug 38 being inserted through an adapted slot in the manner of a guillotine,

a pair of mirror-symmetrical arms 41 which are coupled at one end to the second end portion 36 and at the other end to the fixing assembly 18 for fixing the seat 10 to a wall at a coupling point that is eccentric with respect to the rotation axis X of the sitting surface 12,

a screw 44 for adjusting the tension of the helical spring 39.

This screw 44 is hereinafter referred to in the rest of the description as second screw 44.

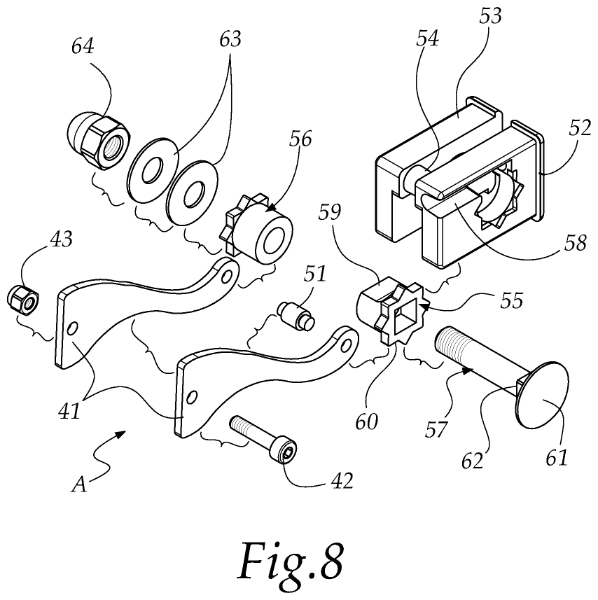

In particular, the pair of arms 41 is coupled to the respective fixing assembly 18 by bolting, with a third screw 42 and a nut 43 (FIG. 7 and FIG. 8 show enlargements of these and of the subsequent elements described), the third screw 42 passing through in succession a first arm 41, the rear end portion 36 and the other arm 41; at the opposite end the arms 41 are coupled to the fixing assembly 18.

The second screw 44 for adjusting the tension of the helical spring 39 engages on an end plate in order to adjust the compression of the spring, as described below.

The first tubular element 33 is fixed below the sitting surface 12 using screws 45 and bushings 46. There are also two plugs 47 for closing the ends of the horizontal tubular element 29 in order to limit noise during the rotation and also the inflow of water.

Each one of the fixing assemblies 18 comprises a bracket 48 for protection, made of plastic material, to be fixed to a wall and a complementary bracket 49, made of metallic material, fixed to the previous bracket, with an L-shaped flat lobe 50 that extends in a cantilever manner, with an arrangement at right angles to the fixing wall, and having a first hole 50a in an eccentric position with respect to the rotation axis X of the sitting surface 12 and a second hole 50b on such rotation axis X.

The pair of arms 41 is coupled to the fixing assembly 18 at the first hole 50a, which is in an eccentric position with respect to the rotation axis X, using a peg 51.

The means for adjusting the tilting force 14 also comprise, again with respect to each group of elements, a screw 57 for rotating the sitting surface 12, with the shank along the rotation axis X, which couples the first tubular element 33 to the respective fixing assembly 18, a nut 64 to be screwed onto the screw 57 and at least one Belleville spring 63, two in the example shown, between the wall of the first tubular element 33 and the nut 64. Hereinafter the screw 57 is referred to in the text of the description as fourth screw 57.

The first tubular element 33 is coupled to the fixing assembly 18 at the second hole 50b.

More specifically, a pair of elements 52 and 53 is mounted at the rear in the first tubular element 33, which are parallel and joined together using a horizontal connecting element 54 and which have a lip with which they rest on the perimetric rim of the first tubular element 33.

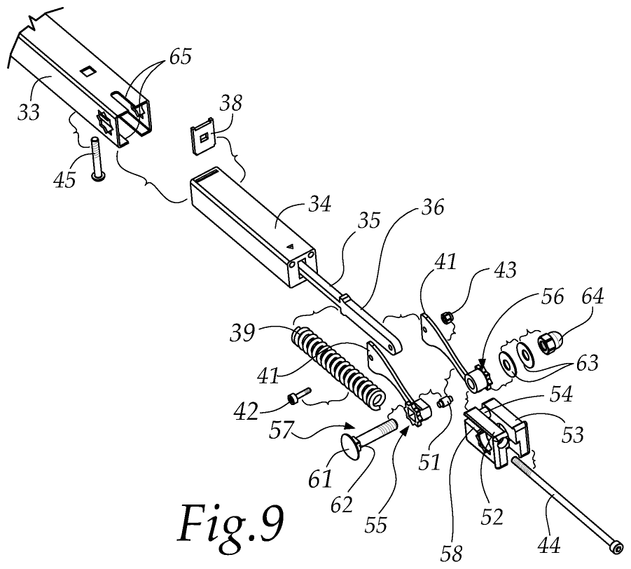

The details of these elements are made clearly visible in FIG. 8 and in FIG. 9. In particular, FIG. 8 shows the grouping indicated with A also in FIG. 6.

The first element 52 and the second element 53 each have a horizontal hole, the two holes being aligned along the rotation axis of the sitting surface 12 in order to receive respective elements, a first friction element 55 and a second friction element 56 which also have aligned holes, for the passage of the fourth screw 57 for rotating the sitting surface 12.

In particular, the first element 52 also has a rear through hole for inserting the second screw 44, which transversely intercepts the horizontal opening and extends for the remaining length of the first element 52 with a groove 58 for the passage of the second screw 44.

The first friction element 55 has, correspondingly, a flattening 59 in order to allow the passage of the second screw 44, while the second friction element 56 has a circular cross-section.

The second screw 44, passing through the first element 52 with its shank, is positioned with its head in an adapted seat, resting on an abutment shoulder.

The first friction element 55 has a crown-like edge 60 with which it is inserted in a complementarily shaped seat of the first element 52, thus providing a shape mating that prevents the first friction element 55 from rotating independently of the first element 52.

Furthermore, the first friction element 55 also has a hole that is square for a first portion thereof and circular for the remaining length, while the second friction element 56 has a circular hole. Correspondingly, the fourth screw 57 has a head 61 that is rounded outside and with a square 62 inside, with which it is positioned in the square part of the hole of the first friction element 55.

The second friction element 56 also has a crown-like edge with which it is inserted in a complementarily shaped seat of the second element 53, thus providing the same shape mating.

At the end opposite to the end in which the fourth screw 57 is inserted, there are, as mentioned, the two Belleville springs 63 and the nut 64.

The first friction element 55 is on the outside of the structure 10, while the second 56 is on the inside. The two groups of elements of the means for adjusting the tilting force 14 are mounted symmetrically.

The first tubular element 33 has openings on mutually opposite sides which correspond with the holes on the two elements 52 and 53 and which also have a crown-like shape for inserting the two friction elements 55 and 56, and a pair of slits 65 open at the rear end and on opposite sides, above and below with respect to the position of use of the seat which brings the element 33 to the horizontal.

There are also adjustable threaded pins 67 (indicated in FIG. 6) inserted in adapted holes on the sitting surface 12, on the side 15, with respective helical springs 66 that prevent their free rotation. The threaded pins 67 abut on the flat lobe 50, so limiting the possibility for rotation of the sitting surface 12 about the axis X. The pins 67 act as devices for the fine adjustment of the vertical position of the sitting surface and of the safety distance to prevent fingers from being crushed between seat and wall.

In order to clarify the operation of the seat, below is a description of how the elements are assembled in order to provide the means for adjusting the tilting force 14.

The first tubular element 33 is fixed below the sitting surface 12 using the screws 45 and the bushings 46.

The helical spring 39 is inserted in the second tubular element 34.

The second tubular element 34 is closed with the plug 38 inserted in the adapted slot in the manner of a guillotine and the rod 35 is inserted in the second tubular element 34 with the first and second end portions 36 and 37 protruding from it.

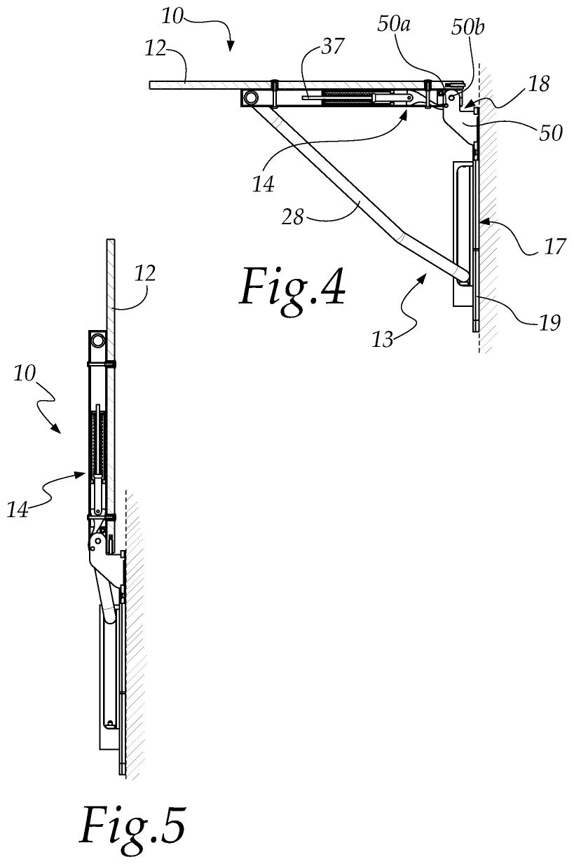

The helical spring 39 is thus accommodated inside the second tubular element 34, around the rod 35, between the plug 38 and the shoulder 40 of the rod 35, as shown in FIGS. 4 and 5.

The arms 41 are coupled at one end on opposite faces of the rear end portion 36, which is conveniently flat.

The second tubular element 34 is inserted in the first tubular element 33, with the arms 41 protruding to the rear from both.

The first element 52 and the second element 53 are inserted in the first tubular element 33, at the rear end.

The two friction elements 55 and 56 are inserted transversely from outside in succession in the holes of the tubular element 33 and of the elements 52 and 53, and are positioned with the crowns in the complementarily-shaped spaces.

The fourth screw 57 is then inserted in succession in the hole of the first friction element 55 and in the hole of the second friction element 56 and the nut 64 is screwed onto it with the interposition, between the nut and the wall of the first tubular element 33, of the Belleville springs 63.

The second screw 44 is inserted from the rear part in the first element 52 and is screwed on the end of the second tubular element 34 that faces toward the second screw 44.

By screwing the second screw 44, the second tubular element 34 gets closer and at the same time the helical spring 39 is compressed between the plug 38 and the shoulder 40.

The arms 41 are coupled at the other end, the rear end, to the L-shaped flat lobe 50 of the fixing assembly 18, at the hole 50a, therefore in an eccentric position with respect to the rotation axis X, using the peg 51.

The coupling in an eccentric position enables the arms 41 to act as struts, pushing the rod 35 to compress the helical spring 39 up to the horizontal position of the sitting surface 12.

The translation of the rod 35 and consequent compression of the helical spring 39 is evident observing FIGS. 5 and 4 in succession, as it is evident the vertical translation of the element 28 in the lateral openings of the first fixing assembly 17.

The means for adjusting the tilting force 14 make it possible in particular to adjust the balancing of the forces by acting on the second screw 44 and to adjust the friction force on the rotation by acting on the Belleville springs 63, by way of tightening the nut 64.

Substantially with the first adjustment, by acting on the second screw 44, the second tubular element 34 is made to translate inside the first tubular element 33, thus modifying the compression of the helical spring 39.

By increasing the compression of the helical spring 39, the force to be applied in order to tilt the sitting surface 12 is increased.

The friction force on the other hand is varied by acting on the compression of the Belleville springs 63: since the two friction elements 55 and 56 protrude slightly from the profile of the first tubular element 33, by tightening the nut 64 the Belleville springs 63 are compressed against the second friction element 56 and, at the same time, the head 61 of the fourth screw 57 is compressed against the first friction element 55, thus increasing the friction force.

The two friction elements 55 and 56 are in fact free to move along the rotation axis X with respect to the elements 52, 53 and to the tubular element 33 and they rotate integrally with them about the axis X by virtue of the crown-like shape mating. At the same time the flat surfaces of the two friction elements 55 and 56 abut against the side walls of the flat lobe 50, therefore by screwing the nut 64, and so compressing the Belleville springs 63, more friction is generated between the friction elements 55 and 56 on the side walls of the L-shaped flat lobe 50.

Adjustment of the friction ensures the slowing of the sitting surface 12 in every position, including intermediate, and prevents uncontrolled and accidental tilting.

Therefore the friction also prevents the accidental slipping of the sitting surface from a vertical or intermediate position to the horizontal position if the springs 39 are not sufficiently compressed and also, conversely, the possible return to the vertical position by virtue of the same springs 39.

The means for adjusting the tilting force 14 can be used during the installation of the seat and also during extraordinary maintenance, even with the seat installed on a wall, because both adjustments, of balancing and of friction, are conducted from outside, at the rear end of the first tubular element 33, with the sitting surface 12 in the position of non-use.

It should be noted that the tilting mechanism is provided using solutions that prevent areas of stagnation of humidity, there being no open cavities that do not drain water (for example the element 28 is a tube in which the openings are closed by welded plugs).

It should also be noted that the mechanism and the components are preferably made of corrosion-free materials, such as stainless steel.

In practice it has been found that the disclosure fully achieves the intended aim and advantages by providing a seat that is capable of ensuring a balanced tipping of the sitting surface, with the application of a force equal to or less than that specified by the prescriptions of the ADA2010 standard (therefore easily movable by people with disabilities), thus preventing the sitting surface from tilting or returning to the vertical inactive position accidentally or suddenly.

The disclosure thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1. A folding seat comprising: a supporting structure configured to be fixed to a wall, for a sitting surface configured to be tilted from a vertical inactive position to a horizontal active position by a tilting mechanism, said seat further comprising means for adjusting a tilting force.

2. The seat according to claim 1, wherein said means for adjusting the tilting force comprise a group of elements installed at each side of said sitting surface, with an adjustable helical tension spring connected to a fixing assembly for fixing the seat to a wall at a coupling point that is eccentric with respect to the rotation axis of said sitting surface.

3. The seat according to claim 2, wherein said group of elements also comprises:
a first tubular element installed below said sitting surface and at right angles to the wall when said sitting surface is in a horizontal active position,
a second tubular element configured to translate in said first tubular element,
a rod configured to translate in said second tubular element, protrudes from said second tubular element with a first end portion, and also has a second end portion,
a flat plug at one end of said second tubular element which is provided with a central hole for said first end portion of said rod, said helical spring being installed around said rod, between said plug and a shoulder of said rod, inside the second tubular element,
a pair of mirror-symmetrical arms coupled at one end to said second end portion and at another end to said fixing assembly for fixing said seat to a wall at a coupling point that is eccentric with respect to the rotation axis of said sitting surface, and
a screw for adjusting the tension of said helical spring.

4. The seat according to claim 3, wherein—said fixing assembly comprises a bracket and a complementary bracket with an L-shaped flat lobe that extends in a cantilever manner and has a first hole in an eccentric position with respect to the rotation axis of said sitting surface and a second hole disposed on said rotation axis.

5. The seat according to claim 3, wherein said pair of arms is coupled to said fixing assembly at said first hole.

6. The seat according to claim 3, wherein said means for adjusting the tilting force also comprise, again with respect to each group of elements, a screw for rotating the sitting surface, with the shank along the rotation axis, which couples said first tubular element to the respective fixing assembly, a nut to be screwed onto said screw and at least one Belleville spring, between said first tubular element and said nut.

7. The seat according to claim 4, wherein said first tubular element is coupled to said fixing assembly at said second hole.
